(19) United States
(12) Patent Application Publication
(10) Pub. No.: US 2008/0292526 A1
(43) Pub. Date: Nov. 27, 2008

(54) Method for the Production of Double Metal Cyanide Complex Catalysts

(75) Inventors: Edward Bohres, Mannheim (DE); Michael Stosser, Neuhofen (DE); Ludwig Volkel, Limburgerhof (DE); Raimund Ruppel, Dresden (DE); Eva Baum, Schwarzheide (DE); Norbert Wagner, Mutterstadt (DE); Jorg Sundermeyer, Marburg (DE); Udo Garrelts, Marburg (DE); Michael Zirnstein, Schriesheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/913,484

(22) PCT Filed: May 2, 2006
(86) PCT No.: PCT/EP2006/061962

§ 371 Date: Jul. 1, 2008

(30) Foreign Application Priority Data
May 2, 2005 (DE) 10 2005 020 347.7

(51) Int. Cl. C01C 3/14; C01C 3/20; C01B 21/20; C01G 1/04

(52) U.S. Cl. 423/365; 423/366

(57) ABSTRACT

Process for preparing double metal cyanide catalysts of the general formula (I)

M²ₐ[M¹(CN)ᵣXₜ]_{b} (I)

where
M² is preferably Co(III) or Fe(III), and
M¹ is preferably Zn(II),
X is a group other than cyanide which forms a coordinate bond to M¹ and is selected from the group consisting of carbonyl, cyanate, isocyanate, nitrile, thiocyanate and nitrosyl,
a, b, r, t are integers which are selected so that the compound is electrically neutral,
   by reacting
a) a cyanometallic acid of the general formula (II)
   H_{w}[M¹(CN)ᵣ(X)ₜ]
   where M¹ and X are as defined above,
   r and t are as defined above and w is selected so that the compound is electrically neutral,
      with
b) a readily protolyzable metal compound (IIIa)
   M²R_{w}
   and/or (IIIb)
   M²RᵤYᵥ,
   where M² is as defined above,
   the groups R are identical or different and are each the anion of a very weak protic acid having a pKₐ of ≧20, and
   Y is the anion of an inorganic mineral acid or a moderately strong to strong organic acid having a pKₐ of from −10 to +10,
   w corresponds to the valence of M²,
   u+v corresponds to the valence of M², with u and v each being at least 1,
      with the reaction being carried out in a nonaqueous, aprotic solvent.

The invention relates to a process for preparing double metal cyanide catalysts (DMC catalysts), the DMC catalysts themselves and also their use.

To produce polyurethane foams having a broad range of properties, it is necessary to have tailored polyether polyols. For example, long-chain polyols are used for flexible foams and shorter-chain polyols are used for rigid foams.

Polyether polyols are prepared from alkylene oxides in the presence of a starter and various catalysts such as potassium hydroxide, hydrophobicized double layer oxides, Lewis acid systems and DMC compounds. Long-chain polyether polyols having a low content of unsaturated constituents are of increasing economic interest. DMC compounds in particular have been found to be useful as catalysts for preparing such polyether polyols.

According to F. E. Bailey, Jr, J. V. Koleske, Alkylene Oxides and their Polymers, Vol. 35, 1991, DMC catalysts are prepared by combining zinc chloride with potassium hexacyanocobaltate or calcium hexacyanocobaltate in water. A catalyst having an increased activity is obtained when an organic solvent, e.g. ethylene glycol or diethylene glycol, is used in place of water.

WO 99/16775 discloses the preparation of crystalline DMC catalysts by reacting aqueous solutions of cyanometallic acids, for example hexacyanocobaltic(III) acid, with aqueous solutions of metal carboxylates, preferably zinc formate, zinc acetate and zinc proprionate. After the aqueous solutions have been combined, water-miscible, heteroatom-comprising components can be added as ligands to the resulting aqueous suspension.

However, the DMC catalysts known from the prior art are still capable of improvement in terms of their induction behavior.

It is an object of the invention to provide improved DMC catalysts.

A further object of the invention is to provide an alternative process for preparing DMC catalysts.

The object is achieved by a process for preparing double metal cyanide catalysts of the general formula (I)

M²ₐ[M¹(CN)ᵣXₜ]_{b} (I)

where
M¹ is a metal ion from the group consisting of Zn(II), Fe(II), Co(III), Ni(II), Mn(II), Co(II), Sn(II), Pb(II), Fe(III), Mo(IV), Mo(VI), Al(III), V(IV), V(V), Sr(II), W(IV), W(VI), Cu(II) and Cr(III),
M² is a metal ion from the group consisting of Sr(I), Mg(II), Zn(II), Fe(II), Fe(III), Co(III), Cr(III), Mn(II), Mn(III), Ir(III), Rh(III), Ru(II), V(IV), V(V), Co(II), Cr(II), Ti(IV),
X is a group other than cyanide which forms a coordinate bond to M¹ and is selected from the group consisting of carbonyl, cyanate, isocyanate, nitrile, thiocyanate and nitrosyl,
a, b, r, t are integers which are selected so that the compound is electrically neutral,
   by reacting
   a) a cyanometallic acid of the general formula (II)

H_{w}[M¹(CN)ᵣ(X)ₜ]
where M¹ and X are as defined above,
r and t are as defined above and w is selected so that the compound is electrically neutral,
with
   b) a readily protolyzable metal compound (IIIa)

M²R_{w}
and/or (IIIb)

M²RᵤYᵥ,
where M² is as defined above,
the groups R are identical or different and are each the anion of a very weak protic acid having a pKₐ of ≧20, and
Y is the anion of an inorganic mineral acid or a moderately strong to strong organic acid having a pKₐ of from −10 to +10,
w corresponds to the valence of M²,
u+v corresponds to the valence of M², with u and v each being at least 1,
   with the reaction being carried out in a nonaqueous, aprotic solvent.

The process of the invention is carried out in a nonaqueous medium. The DMC catalysts prepared according to the invention can be obtained as pumpable gels and can also be used as such. This dispenses with filtration and drying steps and the handling of solids.

In the cyanometallic acid (II), preference is given to

r=4-6,
t=0-2.

In the metal compound (IIIa) or (IIIb), preference is given to

w=2 or u+v=2.

Particularly preferred metal ions M² are Co(III) and Fe(III).

A particularly preferred metal ion M¹ is Zn(II).

Cyanometallic acids (II) are compounds which can be handled very readily in aqueous solution. A number of processes for preparing cyanometallic acids are known. For example, they can be prepared from the alkali metal cyanometalate via the silver cyanometalate, as described in W. Klemm et al., Z. Anorg. Allg. Chem. 308 (1961) 179. Furthermore, alkali metal or alkaline earth metal cyanometalates can be converted into the cyanometallic acid by means of an acid ion exchanger, cf. F. Hein, H. Lilie, Z. Anorg. Allg. Chem. 270 (1952) 45, A. Ludi et al., Helv. Chim. Acta 50 (1967) 2035. Further possible methods of synthesis are described in G. Brauer (editor) “Handbuch der präparativen anorganischen Chemie”, Ferdinand Enke Verlag, Stuttgart 1981.

Preferred cyanometallic acids (II) are hexacyanocobaltic(III) acid and hexacyanoferric(III) acid.

Suitable metal compounds (IIIa) and (IIIb) are, for example, dimethylzinc, diethylzinc, di-n-butylzinc, diisopropylzinc, diisobutylzinc, diethylaluminum cyanide, trimethylaluminum, triisobutylaluminum, triethylaluminum, tri-n-propylaluminum, tri-n-octylaluminum, tri-n-decylaluminum, tri-n-hexylaluminum, bis(tetramethylcyclopentadienyl)manganese, diethylmagnesium, di-n-butyl-magnesium, n-butylethylmagnesium, strontium 2,2,6,6-tetramethyl-3,5-heptanedionate, bis(pentamethylcyclopentadienyl)strontium, 1,1′-dimethyl-ferrocene, ferrocene, benzoylferrocene, cyclopentadienyidicarbonyl iron dimer, bisindenyliron, bis(pentamethylcyclopentadienyl)iron, nickelocene, cyclopentadienylcarbonylnickel dimer, bis(pentamethylcyclopentadienyl)nickel, cobaltocene, bis(ethylcyclopentadienyl)cobalt, bis(pentamethylcyclopentadienyl)cobalt, bis(cyclopentadienyl)manganese, bis(pentamethylcyclopentadienyl)manganese, bis(cyclopentadienyl)titanium dichloride, bis(pentamethylcyclopentadienyl)titanium dichloride, bis(cyclopentadienyl)dicarbonyltitanium(II) and bis(cyclopentadienyl)dimethyltitanium.

Preferred metal compounds (IIIa) are dialkylzinc compounds such as dimethylzinc, diethylzinc, di-n-butylzinc, diisopropylzinc and diisobutylzinc, in particular diethylzinc.

The reaction of the cyanometallic acid (II) with the metal compound (IIIa) or (IIIb) is generally carried out in a nonaqueous, dipolar or nonpolar aprotic solvent. Suitable aprotic solvents are, for example, dimethyl sulfoxide (DMSO), dimethylformamide (DMF), sulfolane, carbon disulfide, ethylene glycol dimethyl ether, diethylene glycol dimethyl ether and N-methylpyrrolidone (NMP), with preference being given to DMSO, DMF and NMP.

The reaction can be carried out in the presence of one or more further organic components which function as surface-active components for controlling the catalyst morphology and/or as chemically bound ligands. This further organic component can equally well be added to the product solution or suspension comprising the DMC compound (I) after the reaction. Preferred further organic components are selected from the group consisting of polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylamide-co-maleic acid), polyacrylonitrile, polyalkyl acrylates, polyalkyl methacrylates, polyvinyl methyl ethers, polyvinyl ethyl ethers, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkylenimines, maleic acid and maleic anhydride copolymers, hydroxyethylcellulose, polyacetates, ionic surface-active and interface-active compounds, bile acids and salts, esters and amides thereof, carboxylic esters of polyhydric alcohols and glycosides.

The reaction can be carried out batchwise, semicontinuously or continuously.

The DMC catalysts (I) prepared according to the invention can be used as catalysts or for the production of supported catalysts.

For example, the DMC catalyst (I) can be isolated from the solution obtained in the reaction by means of customary solid/liquid separation processes and be used as moist precipitate as catalyst, or else it can be used as a suspension or gel without prior separation from the solvent.

The DMC catalysts are used for the alkoxylation of compounds having active H atoms by means of alkylene oxides, preferably ethylene oxide, propylene oxide and/or butylene oxide. Active hydrogen atoms are present, for example, in hydroxyl groups or primary and secondary amino groups. The DMC catalysts prepared according to the invention are preferably used for preparing polyether polyols by reacting diols or polyols with ethylene oxide, propylene oxide, butylene oxide or mixtures thereof.

The DMC catalysts prepared according to the invention display a particularly good “induction behavior”, i.e. the alkoxylation reaction commences immediately on addition of the alkylene oxide to the compound having active H atoms which is to be alkoxylated. This makes itself evident in an extremely rapid drop in pressure after the addition of alkylene oxide due to the immediate commencement of the consumption of the alkylene oxide by the reaction.

The present invention also provides the DMC catalysts prepared according to the invention themselves and also their use for the alkoxylation of compounds having active H atoms, preferably for the alkoxylation of diols or polyols by means of ethylene oxide, propylene oxide, butylene oxide or mixtures thereof.

The DMC catalyst of the invention is used in amounts of generally from 5 to 5000 ppm, preferably from 10 to 1000 ppm, particularly preferably from 15 to 500 ppm, based on the amount of product obtained. The alkoxylation can be carried out as a batch, semibatch or continuous process using all modes of operation known from the prior art.

The invention is illustrated by the following examples.

### EXAMPLES

### Preparation of DMC Catalysts

### Example 1

3.98 g (17.5 mmol) of H₃Co(CN)₆.0.5H₂O (hexacyanocobaltic(III) acid) were dissolved in 250 ml of dry DMF at 45° C., admixed with 3.24 g of ZnEt₂ (26.3 mmol; 27.35 g of an 11.97% strength by weight solution in toluene), the mixture was stirred at 45° C. for 2 hours and allowed to stand overnight at RT. This resulted in formation of a white suspension (267 g) which was not treated further.

### Example 2

3.97 g (17.5 mmol) of H₃Co(CN)₆.0.5H₂O were dissolved in 250 ml of dry DMF at 40° C., admixed with 5.4 g of ZnEt₂ (43.8 mmol; 45.4 g of an 11.97% strength by weight solution in toluene), the mixture was stirred at 45° C. for 2 hours and allowed to stand overnight at RT. This resulted in formation of a turbid fluid gel (269 g) which was not treated further.

### Example 3

3.97 g (17.5 mmol) of H₃CO(CN)₆.0.5H₂O were dissolved in 150 ml of dry DMSO at RT, admixed with 4.44 g of ZnEt₂ (36 mmol, 36.15 g of an 11.97% strength by weight solution in toluene), the mixture was stirred at 45° C. for 1 hour and allowed to stand overnight at RT. This resulted in formation of a pink gel (208 g) which was not treated further.

### Example 4

3.97 g (17.5 mmol) of H₃CO(CN)₆.0.5H₂O were dissolved in 100 ml of H₂O at 45° C., giving a yellowish solution. 4.40 g of ZnEt₂ (35 mmol; 36.8 g of an 11.97% strength by weight solution in toluene) were added to this solution over a period of 30 minutes, the mixture was stirred at 45° C. for 2 hours and allowed to stand overnight at RT. A pink precipitate was formed. The reaction mixture was centrifuged and the precipitate was washed once with 80 ml of water, once with 80 ml of MeOH and once with 80 ml of Et₂O, with each washing step including a 10 minute treatment with ultrasound. The precipitate was dried to constant weight at 60° C. under reduced pressure.

Yield: 6.88 g of solid product.

### Example 5

100 ml of MeOH (abs) were added to 13.29 g (20 mmol) of zirconium 2-ethylhexanoate. A sticky ocher precipitate was formed and this was dispersed by treatment with ultrasound and subsequent vigorous stirring. After heating to 40° C., a solution of hexacyanocobaltic acid (4.50 g, 20 mmol) in 200 ml of MeOH (absolute) which was at 40° C. was added and the mixture was stirred at 40° C. for 30 minutes. Some precipitate was formed, but the major part of the ocher-colored solid had not reacted. The reaction mixture was treated with ultrasound for 2.5 hours, stirred at 40° C. for 8 hours, and treated with ultrasound for a further 2 hours. The solid was filtered off, washed twice with MeOH and dried at 60° C. under reduced pressure. 3.65 g of solid product were obtained.

### Example 6

3.28 g of hexacyanocobaltic acid were dissolved in 220 ml of dry methanol and, while stirring vigorously at room temperature, 23.31 g of an 11.97% strength by weight solution of diethylzinc in toluene were added over a period of five minutes, resulting in formation of a white precipitate and vigorous evolution of gas. The mixture was stirred for another 12 hours approximately. The precipitate was subsequently centrifuged off, washed with methanol and dried under reduced pressure. Yield: 4.1 g of catalyst.

### Example 7

3.97 g of hexacyanocobaltic acid were dissolved in 250 ml of dry dimethylformamide at room temperature, admixed with 36.15 g of an 11.97% solution of diethylzinc in toluene, the mixture was stirred at 45° C. for 1 hour and allowed to stand overnight at RT. A milky gel was formed. The gel was used as catalyst without further treatment.

### Example 8

4.00 g of hexacyanocobaltic acid were dissolved in 250 ml of dry dimethylformamide at 45° C. and a mixture of 49.6 g of an 11.0% strength by weight solution of diethylzinc in toluene and 20 ml of dimethoxyethane was added over a period of 15 minutes, the mixture was stirred at 45° C. for 1 hour and allowed to stand overnight at room temperature. A milky gel was formed. The gel was used as catalyst without further treatment.

### Comparative Example 1

7.0 g of potassium hexacyanocobaltate were taken up in 300 ml of ethylene glycol and admixed while stirring with a mixture of 4.09 g of zinc dichloride in 150 ml of ethylene glycol. A white precipitate was formed. The suspension was used without further work-up.

### Comparative Example 2

13.74 g of a 4.8% strength by weight solution of hexacyanocobaltic acid (3.01 mmol of H₃CO(CN)₆) are slowly added to a solution of 0.82 g (6 mmol) of ZnCl₂ in 10 ml of methanol over a period of 10 minutes while stirring. A fine, white precipitate is formed. After the addition is complete, the dispersion is stirred for another 1 hour.

### Ethoxylation

### General Method

10 g of the respective starter together with 25-5000 ppm of the respective catalyst (metal content based on the amount of the batch) are degassed at about 15 mbar and 75° C. for 75 minutes. The reaction mixture is subsequently sparged with nitrogen. 2.0 g of the starter/catalyst suspension are weighed into a 5 ml experimental reactor equipped with pressure and temperature measuring facilities. The experimental reactor is flushed with nitrogen and heated to 140° C. 1.0 g of ethylene oxide is subsequently metered in continuously at a metering rate of 1 ml/min from a separately connected ethylene oxide stock vessel.

### Example 9

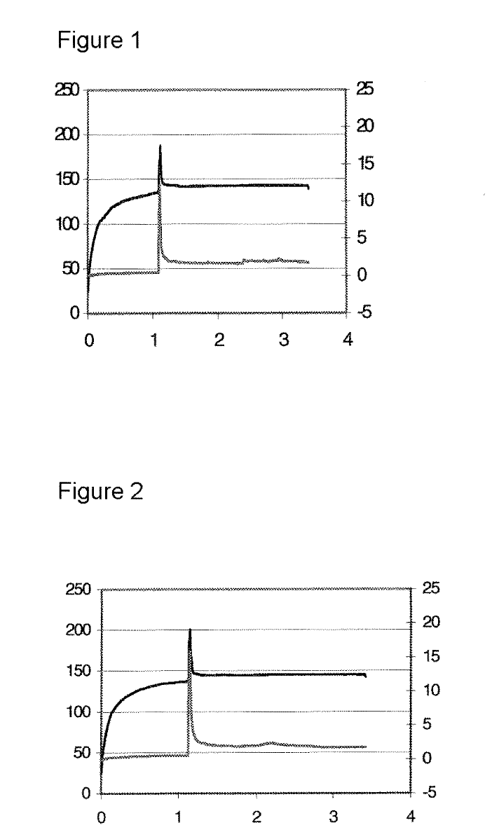

1.81 g of a mixture of 2-propylheptanol as starter and 5000 ppm of the catalyst from example 8 are placed in the experimental reactor. 1 gram of ethylene oxide is metered in over a period of 1 minute (molar ratio of starter:alkylene oxide=about 1:3). FIGS. 1 and 2 show the pressure and temperature curves for 2 different experiments. Here, the temperature in ° C. (upper curve; left-hand axis) and the pressure in bar (lower curve; right-hand axis) are plotted against the time in min. The very rapid drop in pressure (lower curve) after commencement of the addition of ethylene oxide can be seen in the graph.

### Comparative Example 3

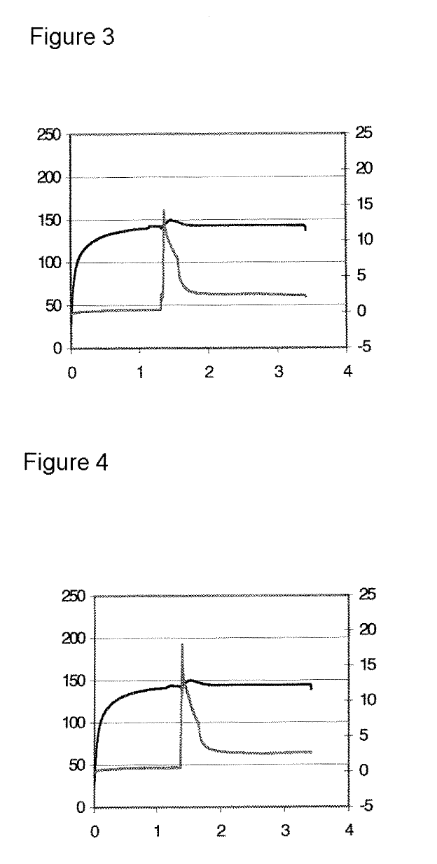

2.26 g of a mixture of 2-propylheptanol as starter and 5000 ppm of the catalyst from comparative example 1 are placed in the experimental reactor. 1 gram of ethylene oxide is metered in over a period of 1 minute (molar ratio of starter:alkylene oxide=about 1:3.3). FIGS. 3 and 4 show the pressure and temperature curves for 2 different experiments. Here, the temperature in ° C. (upper curve; left-hand axis) and the pressure in bar (lower curve; right-hand axis) are plotted against the time in min. A significantly delayed drop in pressure (lower curve) after commencement of the addition of ethylene oxide can be seen in the graph.

### Example 10

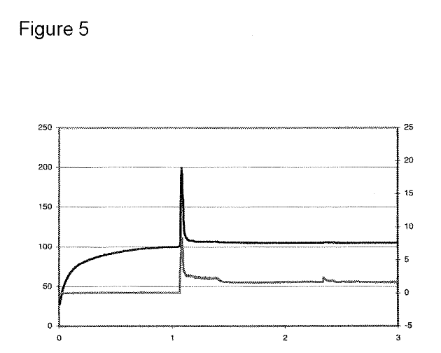

1.94 g of a mixture of 2-propylheptanol as starter and 4000 ppm of the catalyst from example 2 are placed in the experimental reactor. 1 gram of ethylene oxide is metered in over a period of 1 minute (molar ratio of starter:alkylene oxide=about 1:3). FIG. 5 shows the pressure and temperature curves. Here, the temperature in ° C. (upper curve; left-hand axis) and the pressure in bar (lower curve; right-hand axis) are plotted against the time in min. A rapid drop in pressure (lower curve) after commencement of the addition of ethylene oxide can be seen in the graph.

### Example 11

200.0 g (1.0 mol) of tridecanol N and 18.2 g of the catalyst suspension from example 7, corresponding to 500 ppm based on the amount of the batch, are placed in a 2 l steel reactor. The mixture is heated to 100° C. and degassed at 10 mbar for two hours. The vacuum is subsequently broken by means of nitrogen. The mixture is heated to 135° C. and 200.0 g (3.45 mol) of propylene oxide are metered in over a period of 50 minutes, with the pressure fluctuating between 0.2 and 1.6 bar. After the addition of propylene oxide is complete, the mixture is allowed to react until the pressure is constant and is cooled to 100° C. It is subsequently allowed to react further at 1 mbar for 30 minutes. The reaction product is subsequently filtered off by means of a Seitz-Supradur 200 filter.

Output: 411.8 g (theory: 418.2 g)

Residual alcohol content: 0.8% by weight

OH number: 127 mg KOH/g

### Example 12

200.0 g (1.0 mol) of tridecanol N and 0.2 g of the dried catalyst from example 6, corresponding to 500 ppm based on the amount of the batch, are placed in a 2 l steel reactor. The mixture is heated to 100° C. and degassed at 10 mbar for two hours. The vacuum is subsequently broken by means of nitrogen. The mixture is heated to 135° C. and 200.0 g (3.45 mol) of propylene oxide are metered in over a period of 50 minutes, with the pressure fluctuating between 0.4 and 8 bar. After the addition of propylene oxide is complete, the mixture is allowed to react until the pressure is constant and is cooled to 100° C. It is subsequently allowed to react further at 1 mbar for 30 minutes. The reaction product is subsequently filtered off by means of a Seitz-Supradur 200 filter.

Output: 373.7 g (theory: 400.2 g)

Residual alcohol content: 4.0% by weight

OH number: 150 mg KOH/g

1: A process for preparing double metal cyanide catalysts of the general formula (I)
M²ₐ[M¹(CN)ᵣXₜ]_{b} (I)
where M¹ and M² are metal ions, and
M¹ is Zn(II),
M² is selected from the group consisting of Fe(III) and Co(III),
X is a group other than cyanide which forms a coordinate bond to M¹ and is selected from the group consisting of carbonyl, cyanate, isocyanate, nitrite, thiocyanate and nitrosyl,
a, b, r, t are integers which are selected so that the compound electrically neutral,
by reacting
a) a cyanometallic acid of the general formula (II)
H_{w}[M¹(CN)ᵣ(X)ₜ]
where M¹ and X are as defined above,
r and t are as defined above and w is selected so that the compound is electrically neutral,
with
b) a readily protolyzable metal compound (IIIa)
M²R_{w}
and/or (IIIb)
M²RᵤYᵥ,
where M² is as defined above,
the groups R are identical or different and are each the anion of a very weak protic acid having a pKₐ, of ≧20, and
Y is the anion of an inorganic mineral acid or a moderately strong to strong organic acid having a pKₐ of from −10 to +10,
w corresponds to the valence of M²,
u+v corresponds to the valence of M², with u and v each being at least 1,
with the reaction being carried out in a nonaqueous, aprotic solvent.

2: The process according to claim 1, wherein, in the cyanometallic acid (II),
r=4-6, and
t=0-2.

3: The process according to claim 1, wherein, in the metal compound (IIIa) or (IIIb),
w=2 or u+v=2.

4: The process according to claim 1, wherein the cyanometallic acid (II) is selected from among hexacyanocobaltic(III) acid and hexacyanoferric(III) acid.

5: The process according to claim 1, wherein the metal compound (IIIa) is a dialkylzinc compound.

6: The process according to claim 1, wherein the metal compound (IIIa) is diethylzinc.

7: The process according to claim 1, wherein the solvent is selected from the group consisting of dimethyl sulfoxide, dimethylformamide and N-methylpyrrolidone.

8: A DMC catalyst obtained by the process according to claim 1.

9. (canceled)

10: A process for the alkoxylation of compounds having active H atoms comprising catalyzing the alkoxylation with the DMC catalyst according to claim 8.
